(19) United States
(12) Patent Application Publication
(10) Pub. No.: US 2009/0246310 A1
(43) Pub. Date: Oct. 1, 2009

(54) RESIN IMPRINT STAMPER AND METHOD OF MANUFACTURING THE SAME

(75) Inventors: Masatoshi Sakurai, Tokyo (JP); Seiji Morita, Yokohama-shi (JP); Shinobu Sugimura, Yokohama-shi (JP); Akiko Yuzawa, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/413,242

(22) Filed: Mar. 27, 2009

(30) Foreign Application Priority Data
Mar. 28, 2008 (JP) 2008-087764

(51) Int. Cl. B29C 33/42; B29C 45/14

(52) U.S. Cl. 425/470; 264/225

(57) ABSTRACT

According to one embodiment, a resin imprint stamper formed of a resin material in an annular shape having a through-hole in a central part thereof, including a pattern area formed on a part of a surface thereof in which a plurality of lands and grooves are circumferentially arranged with a track pitch of 100 nm or less, and the pattern height of at most 100 nm, wherein no protrusion and step having a height exceeding 10 μm from a top surface of the pattern area are present in a region less than 3 mm from an end of the pattern area toward an inner periphery thereof.

### CROSS-REFERENCE TO RELATED APPLICATIONS

This application is based upon and claims the benefit of priority from Japanese Patent Application No. 2008-087764, filed Mar. 28, 2008, the entire contents of which are incorporated herein by reference.

### BACKGROUND

1. Field

One embodiment of the present invention relates to a resin imprint stamper applied to the manufacture of a magnetic recording medium that uses discrete track recording technology, and a method of manufacturing the same.

2. Description of the Related Art

When a magnetic recording medium that uses discrete track recording (DTR) technology is manufactured, an imprint stamper on which protruded patterns are formed is pressed against a surface of a resist applied to a substrate having a magnetic recording layer to transcribe the patterns onto the resist, and the magnetic recording layer is processed to form magnetic patterns. Conventionally, the imprint stamper has been manufactured by a Ni electroforming process. When the Ni electroforming process is employed, however, a manufacturing time of about one hour per stamper is required. In contrast, if manufacture of a resin imprint stamper is enabled by an injection molding process, it is possible to shorten the manufacturing time to about 10 seconds per stamper.

In the production of an optical disk in which lands and grooves are formed with a track pitch of 300 nm or more, injection molding is employed. For example, two optical disks manufactured by injection molding are bonded together with a recording layer having a thickness of 30 μm or more interposed between them. When an optical disk in which lands and grooves is formed with a track pitch of 300 nm or more is manufactured by injection molding, resin intrudes into a space formed between a die and a stamper in injection molding, whereby a burr is formed on the inner periphery of the disk (see, for example, Jpn. Pat. Appln. KOKAI Publication No. 2004-310937). However, since the thickness of the recording layer is 30 μm or more, which is sufficiently large, a problem is hardly caused in the bonding process even when the burr is produced. Further, if a step on the inner periphery of the resin imprint stamper produced due to the height difference between the die surface and the stamper surface is made 30 μm or less, a problem is hardly caused in the bonding process.

On the other hand, when it is assumed that a resin imprint stamper is manufactured by injection molding, and a DTR medium having a track pitch of 100 nm or less is manufactured by using the stamper, a magnetic recording layer having the depth of 20 nm or less is formed on a substrate, a resist having a thickness of at most 100 nm and the mask height of at most 100 nm for etching the magnetic layer is applied thereto, the resin imprint stamper is pressed against the resist to transcribe patterns onto the resist, and then the magnetic recording layer is subjected to processing.

If there is a high protrusion or step on the surface of the resin imprint stamper where patterns are transcribed onto such a thin resist having a thickness of 100 nm or less, a gap may be formed between the stamper and the resist, thereby causing a problem that the patterns on the surface of the stamper cannot be transcribed onto the resist.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A to 1C are cross-sectional views showing a method of manufacturing a resin imprint stamper by injection molding;

FIGS. 2A to 2C are cross-sectional views showing a method of reducing a height of a burr on a resin imprint stamper by deforming the burr by means of a press;

FIGS. 3A and 3B are cross-sectional views showing a method of removing a burr by punching out an inner periphery of a resin imprint stamper;

FIGS. 4A to 4E are cross-sectional views showing a method of manufacturing a DTR medium using a resin imprint stamper according to the present invention; and

FIGS. 5A and 5B are plan views of DTR media manufactured by a method according to the present invention.

### DETAILED DESCRIPTION

Various embodiments according to the invention will be described hereinafter with reference to the accompanying drawings. In general, according to one embodiment of the invention, there is provided a resin imprint stamper formed of a resin material in an annular shape having a through-hole in a central part thereof, comprising a pattern area formed on a part of a surface thereof in which a plurality of lands and grooves are circumferentially arranged with a track pitch of 100 nm or less and the thickness of the magnetic layer of 20 nm or less which needs the thickness of the resist of at most 100 nm, wherein no protrusion and step having a height exceeding 10 μm from a top surface of the pattern area are present in a region less than 3 mm from an end of the pattern area toward an inner periphery thereof. According to another embodiment of the present invention, there is provided a method of manufacturing a resin imprint stamper comprising: preparing a master stamper; performing resin injection molding using the master stamper; and eliminating a protrusion and a step having a height exceeding 10 μm from a top surface of a pattern area in a region less than 3 mm from an end of the pattern area toward an inner periphery thereof.

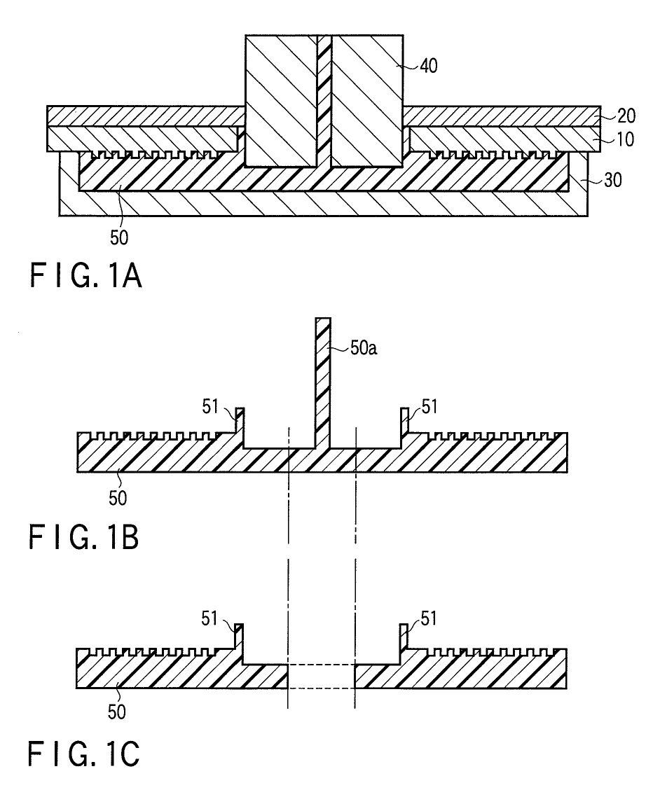

First, a method of manufacturing a resin imprint stamper by injection molding will be described with reference to FIGS. 1A to 1C. A Ni stamper having an annular shape manufactured by using electron beam lithography and electroforming in accordance with an ordinary method is prepared as a master stamper. The resultant Ni stamper is set to an injection molding machine. As shown in FIG. 1A, the rear surface of the Ni stamper 10 is held by a first base die 20, the Ni stamper 10 is opposed to a second base die 30, and the Ni stamper 10 is supported in a state where the Ni stamper 10 is sandwiched in between the two dies. The second base die 30 is in contact with the surface of the Ni stamper 10 at a position outside the outer end of the patterns of the Ni stamper 10. Accordingly, an outer periphery of a resin imprint stamper obtained by injection molding is determined by the position at which the second base die 30 and the Ni stamper 10 are in contact with each other. Further, a thickness of the resin imprint stamper is determined by the distance between the surface of the Ni stamper 10 and the surface of the second base die 30. An injection die 40 is fitted to the central hole of the annular Ni stamper 10 to be fixed. At this time, it is desirable that the surface of the injection die 40 be arranged to be prominent relative to the surface of the Ni stamper 10 toward the second base die 30. Molten resin is injected from the injection die, and the gap between the Ni stamper 10 (and the injection die 40) and the second base die 30 is filled with the molten resin. Although the resin material is not particularly limited, polycarbonate resin is mainly used. The injected molten resin is cooled to the die temperature to be solidified.

As shown in FIG. 1B, the second base die 30 is detached, and the solidified resin molded product (resin imprint stamper) 50 is separated from the Ni stamper 10 and the injection die 40. A solidified resin body 50a formed in the injection flow path remains at the central part of the resin molded product 50. Further, a burr 51 remains at positions on the product corresponding to the gap between the central hole of the Ni stamper 10 and the side surface of the injection die 40.

As shown in FIG. 1C, the central part of the resin molded product including the solidified resin body 50a is punched out to be removed, thereby manufacturing a resin imprint stamper 50 having an annular shape.

The burr 51 is present as an abrupt protrusion having an aspect ratio of the height to the full width at half maximum of 2 or more, or a gentle step having an aspect ratio of less than 2. The shape of the burr 51 differs depending on the injection molding conditions. However, it has been found that when a DTR medium having micropatterns of, for example, a track pitch of 100 nm or less and the thickness of the magnetic layer of 20 nm or less which needs the thickness of the resist of at most 100 nm is manufactured by imprinting using a resin imprint stamper 50 having such a burr, the micropatterns cannot be satisfactorily transcribed in many cases depending on the position and the size of the burr. Specifically, if there is a protrusion or step having a height exceeding 10 μm from the top surface of the pattern area in a region less than 3 mm from the end of the pattern area of the resin imprint stamper 50 toward the inner periphery thereof, it becomes impossible to satisfactorily transcribe the micropatterns. It should be noted that in the manufacturing process of the optical disk, a significant problem has not been caused even when there is a burr having a height of 10 μm or more by virtue of the presence of the recording layer having a thickness of about 30 μm. However, when the resin imprint stamper is applied to the manufacture of the DTR medium, it is necessary to eliminate the influence of the burr.

Next, a method of eliminating the influence of the burr when the resin imprint stamper is applied to the manufacture of the DTR medium in the present invention will be described.

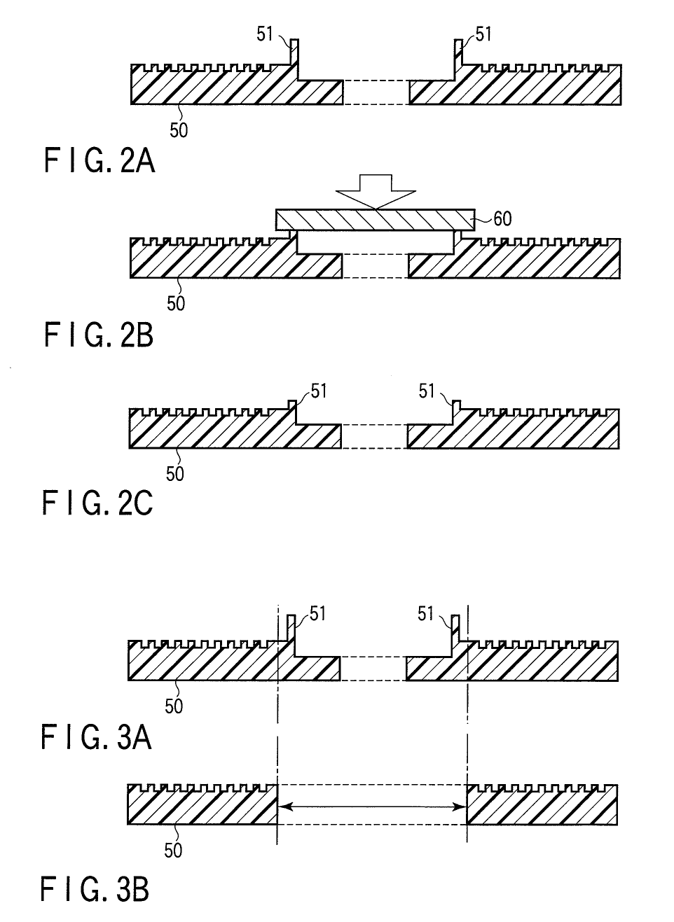

FIGS. 2A to 2C shows a method of reducing the height of a burr on a resin imprint stamper by deforming the burr by means of a press. FIG. 2A shows the resin imprint stamper 50 obtained in FIG. 1C. As shown in FIG. 2B, a repair jig 60 is held to the burr remaining on the inner periphery of the resin imprint stamper 50, and is then pressed against the burr. As shown in FIG. 2C, the burr is thus subjected to plastic deformation, and the height thereof is reduced. It should be noted that the resin may be softened by heating at the time of pressing in FIG. 2B.

FIGS. 3A and 3B show the method of removing the burr by punching out the inner periphery of the resin imprint stamper. FIG, 3A shows the resin imprint stamper 50 obtained in FIG. 1C. As shown in FIG. 3B, the burr is removed by punching out the inner periphery of the resin imprint stamper together with the burr 51. In the resultant resin imprint stamper 50, the burr produced by injection molding is not present.

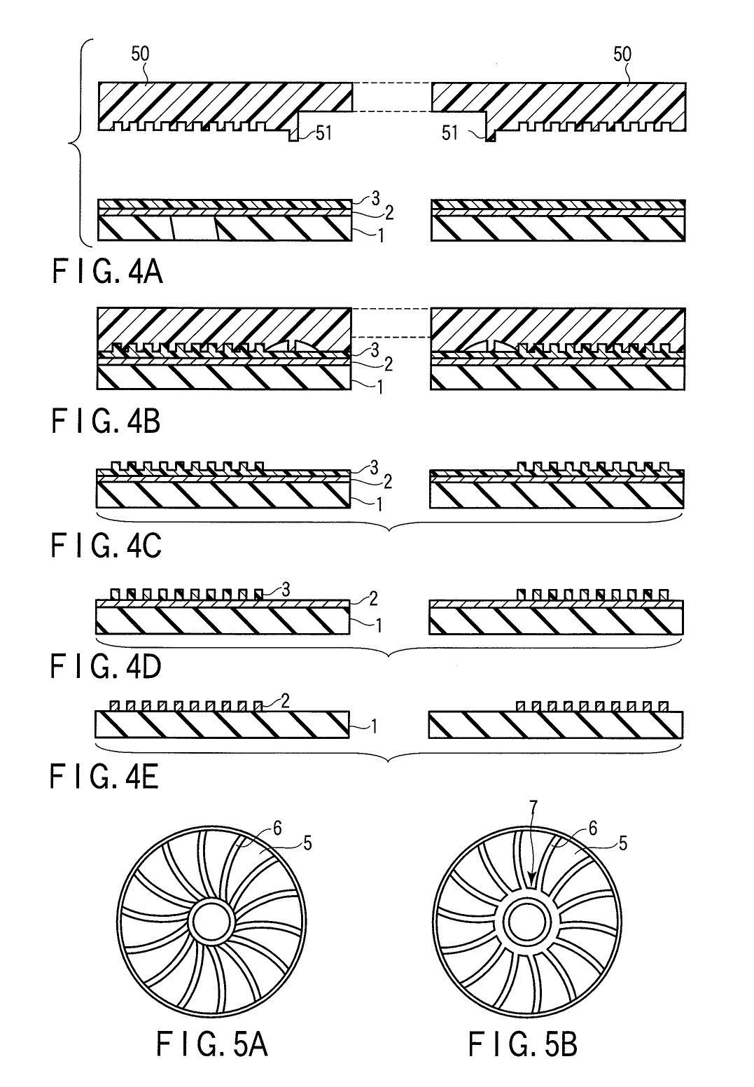

Next, a method of manufacturing a DTR medium using the resin imprint stamper according to the present invention will be described with reference to FIGS. 4A to 4E.

As shown in FIG. 4A, a magnetic recording layer 2 is formed on a substrate 1, and the magnetic recording layer 2 is coated with a resist 3. The protruded patterns of the resin imprint stamper 50 are opposed to the resist 3.

As shown in FIG. 4B, the resin imprint stamper 50 is pressed against the resist 3, thereby transcribing the patterns onto the resist 3. At this time, on the periphery of the burr 51 of the resin imprint stamper 50, a gap is formed between the stamper 50 and the resist 3 in some cases. The size of the gap varies depending on the height and position of the burr 51. Further, if the size of the gap becomes excessively large and the gap reaches the pattern area, the patterns of the resin imprint stamper 50 cannot be transcribed onto the resist 3 in some cases.

As shown in FIG. 4C, the resin imprint stamper 50 is peeled off. Protruded patterns transcribed from the resin imprint stamper 50 are formed on the surface of the resist 3.

As shown in FIG. 4D, the resist residues remaining in the recesses of the resist 3 are removed, and the magnetic recording layer 2 is exposed.

As shown in FIG. 4E, the magnetic recording layer 2 is subjected to a milling process to be processed using the resist pattern as a mask, whereby the desired magnetic patterns are provided.

A nonmagnetic layer is filled between magnetic patterns, if desired, a DLC protective film is formed on the surface, and a lubricant is applied to the surface, whereby a DTR medium is provided.

FIGS. 5A and 5B show plan views of the DTR media obtained by the method described above. In FIGS. 5A and 5B, data zones 5 and servo zones 6 are shown. In the data zone 5, a plurality of lands and grooves are arranged circumferentially with a track pitch of 100 nm or less.

FIG. 5A shows that the transcription of the patterns has been performed satisfactorily, and the desired data zones 5 and the servo zones 6 have been formed

FIG. 5B shows that, although the data zones 5 and the servo zones 6 have been satisfactorily formed partly, a non-transcribed area 7 of the patterns has been formed on the inner periphery of the substrate 1 by the influence of the burr.

Results obtained by checking whether or not transcription of the patterns is performed satisfactorily when resin imprint stampers are manufactured under various conditions, and DTR media are manufactured using the resultant resin imprint stampers will be described below.

### EXAMPLES 1 TO 4

<Specification of DTR Medium>

The specification of the patterns on the DTR medium is as follows. A diameter of the DTR medium is 1.8 inch, and lands and grooves are formed on the data zones with a track pitch of 78 nm. The shape of the track has a land width of 52 nm and a groove width of 26 nm. The pattern formation range has an inner diameter of 18 mm and an outer diameter of 46 mm. A predetermined servo patterns are formed on the servo zones depending on the data zones.

<Specification of Ni Stamper>

A Ni stamper having an annular shape manufactured by using electron beam lithography and electroforming in accordance with an ordinary method is prepared. The Ni stamper has an annular shape with an outer diameter of 80 mm, an inner diameter of 16 mm and a thickness of 0.4 mm, and includes patterns having a height of 50 nm corresponding to the above DTR medium.

<Specification of Injection Molding>

Outer diameter of first base die: 100 mm;

Diameter of contact area of second base die to be in contact with Ni stamper: 55 mm;

Step between contact area of second base die to be in contact with Ni stamper and resin molding surface; 0.4 mm;

Outer diameter of injection die: 16 mm;

Amount of prominent height of injection die from first base die: 0.45 mm.

Polycarbonate is used as the resin material, and injection molding is performed under conditions of the molten resin temperature of 200° C., molding die temperature of 90° C., molding pressure of 40 t and molding time of 10 s.

The inner periphery of the resultant resin molded product is punched out at a position of the diameter of 12 mm, thereby manufacturing a resin imprint stamper.

<Shape of Resin Imprint Stamper>

The shape of the resin imprint stamper made of polycarbonate has an inner diameter of 12 mm, outer diameter of 55 mm and thickness of 0.4 mm, and includes patterns having a height of 50 nm corresponding to the above DTR medium. A thickness of a part inside the inner diameter of 16 mm is 0.35 mm. There is a step of 0.05 mm between the pattern surface and the part inside the inner diameter of 16 mm. A protruded burr having a height of 20 μm and a full width at half maximum of 4 μm is formed circumferentially at a position of the inner diameter of 16 mm, in other words, a position 1 mm from the end of the pattern area toward the inner periphery. The rear surface of the resin imprint stamper is flat.

In Example 1, the above resin imprint stamper was used as it was. In this resin imprint stamper, a protruded burr having a height of 20 μm and a full width at half maximum of 4 μm was formed at a position of the inner diameter of 16 mm.

In Examples 2 to 4, with respect to the above resin imprint stamper, an aluminum disk having a diameter of 17 mm and a thickness of 3 mm was used as a repair jig, the aluminum disk was heated to 80° C., and the aluminum disk was pressed against the inner periphery of the resin imprint stamper under the following pressure, respectively. The shape, i.e., height and full width at half maximum, of the burr after being subjected to this process was observed with an AFM.

Example 2 pressure 5 kgf: height 15 μm, full width at half maximum of 4 μm;

Example 3 pressure 10 kgf: height 10 μm, full width at half maximum of 4 μm;

Example 4 pressure 20 kgf: height 5 μm, full width at half maximum of 4 μm.

### EXAMPLE 5

With respect to the above resin imprint stamper, the part inside the diameter of 17 mm was punched out with a cutter.

### EXAMPLE 6

The inner diameter of the Ni stamper, outer diameter of the injection die, and punching position of the resin imprint stamper were changed as follows.

Inner diameter of Ni stamper: 12 mm;

Outer diameter of injection die: 12 mm;

Punching position for resin imprint stamper: 8 mm.

The resin imprint stamper was taken out of the injection molding machine, and then the inner diameter of the resin imprint stamper was made larger by punching out the inner periphery thereof at a position of the inner diameter of 12 mm. The shape of the burr after this process was observed with an AFM. A protruded burr having a height of 20 μm and a full width at half maximum of 4 μm remained at a position of the inner diameter of 12 mm on the resin imprint stamper.

### EXAMPLE 7

The amount of prominent height of the injection die from the first base die was changed to 0.389 mm. The resultant resin imprint stamper was observed with an AFM, and a step and a burr were identified as follows.

Step between pattern surface and part on inner periphery of inner diameter of 16 mm: step having height of 11 μm on inner periphery;

Burr: at position of inner diameter of 12 mm, height 20 μm, full width at half maximum 4 μm.

An aluminum disk having a diameter of 17 mm and a thickness of 3 mm was used as a repair jig, and the aluminum disk was heated to 80 ° C. and pressed against the inner periphery of the resin imprint stamper. As a result, although the burr could be eliminated, the step having a height of 11 μm on the inner periphery remained.

### EXAMPLE 8

The amount of prominent height of the injection die from the first base die was changed to 0.390 mm. The resultant resin imprint stamper was observed with an AFM, and a step and a burr were identified as follows.

Step between pattern surface and part on inner periphery of inner diameter of 16 mm: step having height of 10 μm on inner periphery;

Burr: at position of inner diameter of 12 mm, height 20 μm, full width at half maximum 4 μm.

An aluminum disk having a diameter of 17 mm and a thickness of 3 mm was used as a repair jig, and the aluminum disk was heated to 80° C. and pressed against the inner periphery of the resin imprint stamper. As a result, although the burr could be eliminated, the step having a height of 10 μm on the inner periphery remained.

(DTR Medium Manufacturing Process)

The resin imprint stampers of Examples 1 to 8 were used to manufacture DTR media by the following process.

A magnetic recording layer having a thickness of 10 nm was deposited on a substrate, and the layer was coated with a UV-curable resist having a thickness of 50 nm by spin coating. The pattern surface of each of the resin imprint stampers was put on to the resist in vacuum and was exposed to the atmosphere, pressed against the resist by atmospheric pressure, and was exposed to UV light for curing the resist, thereby transcribing the patterns to the resist. Thereafter, the resin imprint stamper was peeled off. Protruded patterns having a height of 50 nm were transcribed onto the resist surface. The resist was etched by oxygen RIE by an amount of 20 nm, and the magnetic recording layer was exposed at the recesses of the resist. The height of the protruded patterns on the resist surface was made 40 nm. The magnetic recording layer exposed at the recesses of the resist was etched by Ar ion milling by an amount of 10 nm. The remaining resist was removed by oxygen RIE. A diamond-like carbon having a thickness of 5 nm was deposited on the medium surface, and then a lubricant was applied thereto, whereby a DTR medium was provided.

The pattern surface of each of the magnetic recording media manufactured by using the resin imprint stampers of Examples 1 to 8 was observed with an optical surface analyzer (OSA). Where it was confirmed that the patterns were transcribed up to the inner periphery of the substrate as shown in FIG. 5A, it is referred to as whole-surface transcription. When there was a non-transcribed area 7 in the inner periphery of the substrate as shown in FIG. 5B, the outer diameter of the non-transcribed area 7 was measured. Further, the state of pattern transcription at the position of the innermost periphery of the patterns, i.e., at the position of the diameter of 18 mm was observed. The results are summarized in Table 1.

TABLE 1

| | Position and | Position and height | Diameter of non- | Transcription of |
|---|---|---|---|---|
| | height of step | of protrusion | transcribed area | pattern area |
| Example 1 | 16 mm, −5 μm | 16 mm, 20 μm | 22 mm | NG |
| Example 2 | 16 mm, −5 μm | 16 mm, 15 μm | 20 mm | NG |
| Example 3 | 16 mm, −5 μm | 16 mm, 10 μm | 18 mm | OK |
| Example 4 | 16 mm, −5 μm | 16 mm, 5 μm | Whole-surface | OK |
| | | | transcription | |
| Example 5 | 16 mm, −5 μm | None | Whole-surface | OK |
| | | | transcription | |
| Example 6 | 12 mm, −5 μm | 12 mm, 20 μm | 18 mm | OK |
| Example 7 | 16 mm, +11 μm | None | 19 mm | NG |
| Example 8 | 16 mm, +10 μm | None | 18 mm | OK |

It is found that the pattern transcription up to the inner periphery is enabled even when the height of the burr is 20 μm if the position of the burr is 3 mm or more apart from the innermost periphery of the pattern area as in Example 6. From the results of Examples 1 to 5, it can be seen that if the height of the burr is 10 μm or less, satisfactory transcription is enabled even when the position of the burr is 3 mm or less from the innermost periphery of the pattern area.

From the results of Examples 7 and 8, it can be seen that if the height of the step from the pattern surface is 10 μm or less, satisfactory transcription is enabled even when the position of the step is 3 mm or less from the innermost periphery of the pattern.

The method of the present invention makes it possible to satisfactorily transcribe the patterns onto the resist on the surface of the medium as described above, and to manufacture a DTR medium free from troubles in read and write. Further, injection molding enables to manufacture resin imprint stampers at a rate of 10 seconds per stamper, thereby improving productivity.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A resin imprint stamper comprising:
a resin material in an annular shape comprising a through-hole in a central portion of the annular shape; and
a pattern area on a surface of the resin imprint stamper, the pattern area comprising a plurality of lands and grooves circumferentially aligned with a track pitch of 100 nm or shorter,
wherein a protrusion and a step comprises a height shorter than 10 μm from a top surface of the pattern area in a region shorter than 3 mm from an end of the pattern area toward an inner periphery of the resin imprint stamper.

2. A method of manufacturing a resin imprint stamper comprising:
preparing a master stamper;
injection molding of resin using the master stamper; and
removing a protrusion and a step comprising a height exceeding 10 μm from a top surface of a pattern area in a region shorter than 3 mm from an end of the pattern area toward an inner periphery of the resin imprint stamper.

3. The method of claim 2, further comprising:
reducing the heights of the protrusion and the step by pressing a repair jig against a surface of the resin imprint stamper formed by the injection molding.

4. The method of claim 2, further comprising:
removing a portion of the inner periphery of the resin imprint stamper formed by injection molding in order to remove the protrusion and the step.
